(19) United States
(12) Patent Application Publication
(10) Pub. No.: US 2007/0122670 A1
(43) Pub. Date: May 31, 2007

(54) Fuel cell unit

(75) Inventor: Motoi Goto, Tachikawa-shi (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Kabushiki Kaisha Toshiba

(21) Appl. No.: 11/544,192

(22) Filed: Oct. 6, 2006

(30) Foreign Application Priority Data
Nov. 30, 2005 (JP) 2005-345909

(51) Int. Cl. H01M 8/04

(52) U.S. Cl. 429/26

(57) ABSTRACT

According to one embodiment, a fuel cell unit is provided with a housing, a electromotive section contained in the housing and including an anode and a cathode, a cooling section which cools a fluid having passed through the cathode and separates the fluid into a gas and a liquid, an exhaust pipe which guides, to an outside of the housing, the gas separated by the cooling section, and a heat transfer mechanism which transfers, to the exhaust pipe, part of heat generated by the electromotive section.

### CROSS-REFERENCE TO RELATED APPLICATIONS

This application is based upon and claims the benefit of priority from Japanese Patent Application No. 2005-345909, filed Nov. 30, 2005, the entire contents of which are incorporated herein by reference.

### BACKGROUND

1. Field

One embodiment of the invention relates to a fuel cell unit. For example, it relates to a fuel cell unit that generates exhaust gas during generation of electricity.

2. Description of the Related Art

Attention has recently been paid to the use, as power supplies for electronic devices, such as portable computers, of compact, high-output fuel cell units that are not necessary to be charged. As fuel cell units of this type, direct methanol fuel cells (DMFCs) are known which use an aqueous solution of methanol as fuel.

The electromotive section of a DMFC generates electricity by causing an aqueous solution of methanol to chemically react with oxygen in the air. As a result of the chemical reaction, water vapor and carbon dioxide are produced in the electromotive section. To exhaust gas containing carbon dioxide and water vapor, the DMFC has an exhaust section for exhausting the gas to the outside.

For instance, a power supply system equipped with a fuel cell and heating unit is disclosed in Jpn. Pat. Appln. KOKAI Publication No. 2005-32585. The disclosed heating unit includes heating means, such as a heater, for heating a part of the system or the whole system when the system is stopped. As a result, the system is protected from freezing even when it does not operate.

Many DMFCs incorporate a cooling unit for cooling the exhaust gas. The cooling unit cools the exhaust gas to condense part of the water vapor contained in the exhaust gas to collect water. The collected water is circulated in the DMFC and used to adjust the concentration of the methanol aqueous solution.

The remaining exhaust gas, from which a necessary amount of water has been collected, is exhausted to the outside through the exhaust pipe and outlet. Since the exhaust gas is cooled by the cooling unit to the degree at which water vapor is condensed, saturated water vapor with a humidity of almost 100% is guided to the outlet. Further, in the exhaust pipe leading to the outlet, the temperature of the water vapor gradually reduces.

When the temperature of the exhaust gas is reduced, the water vapor is further condensed, and water droplets may well occur in the exhaust pipe. The droplets may scatter to the outside of the DMFC, or may remain in the DMFC and cause the DMFC to malfunction.

The power supply system disclosed in Jpn. Pat. Appln. KOKAI Publication No. 2005-32585 does not prevent the droplets. Namely, the heating unit employed in the system is developed to protect the system from freezing when the system is stopped.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view illustrating a fuel cell unit according to a first embodiment of the invention;

FIG. 2 is an exemplary perspective view illustrating a state in which a portable computer is mounted on the fuel cell unit of the first embodiment;

FIG. 3 is an exemplary perspective view illustrating a DMFC unit incorporated in the fuel cell unit of the first embodiment;

FIG. 4 is an exemplary schematic view illustrating the configuration of the fuel cell unit of the first embodiment;

FIG. 5 is an exemplary sectional view illustrating an exhaust section and its vicinity incorporated in the fuel cell unit of the first embodiment;

FIG. 6 is an exemplary sectional view illustrating the exhaust section and its vicinity taken along line F6-F6 in FIG. 5;

FIG. 7 is an exemplary sectional view illustrating a heat exchange section incorporated in the fuel cell unit of the first embodiment;

FIG. 8 is an exemplary sectional view illustrating a fuel cell unit according to a second embodiment of the invention;

FIG. 9 is an exemplary perspective view partly in section, illustrating a heat exchange section incorporated in the second embodiment;

FIG. 10 is an exemplary schematic view illustrating the configuration of a fuel cell unit according to a third embodiment of the invention;

FIG. 11 is an exemplary sectional view illustrating an exhaust section and its vicinity incorporated in the fuel cell unit of the third embodiment;

FIG. 12 is an exemplary sectional view illustrating a modification of the fuel cell unit of the third embodiment;

FIG. 13 is an exemplary schematic view illustrating the configuration of a fuel cell unit according to a fourth embodiment of the invention;

FIG. 14 is an exemplary schematic view illustrating the configuration of a fuel cell unit according to a fifth embodiment of the invention;

FIG. 15 is an exemplary schematic view illustrating the configuration of a fuel cell unit according to a sixth embodiment of the invention; and

FIG. 16 is an exemplary schematic view illustrating the configuration of a modification of the fuel cell unit according to the sixth embodiment of the invention.

### DETAILED DESCRIPTION

Various embodiments according to the invention will be described hereinafter with reference to the accompanying drawings. In general, according to one embodiment of the invention, a fuel cell unit is provided with a housing; an electromotive section contained in the housing and including an anode and a cathode; a cooling section which cools a fluid having passed through the cathode and separates the fluid into a gas and a liquid; an exhaust pipe which guides, to an outside of the housing, the gas separated by the cooling section; and a heat transfer mechanism which transfers, to the exhaust pipe, part of heat generated by the electromotive section.

Fuel cell units according to embodiments of the invention will be described with reference to the accompanying drawings.

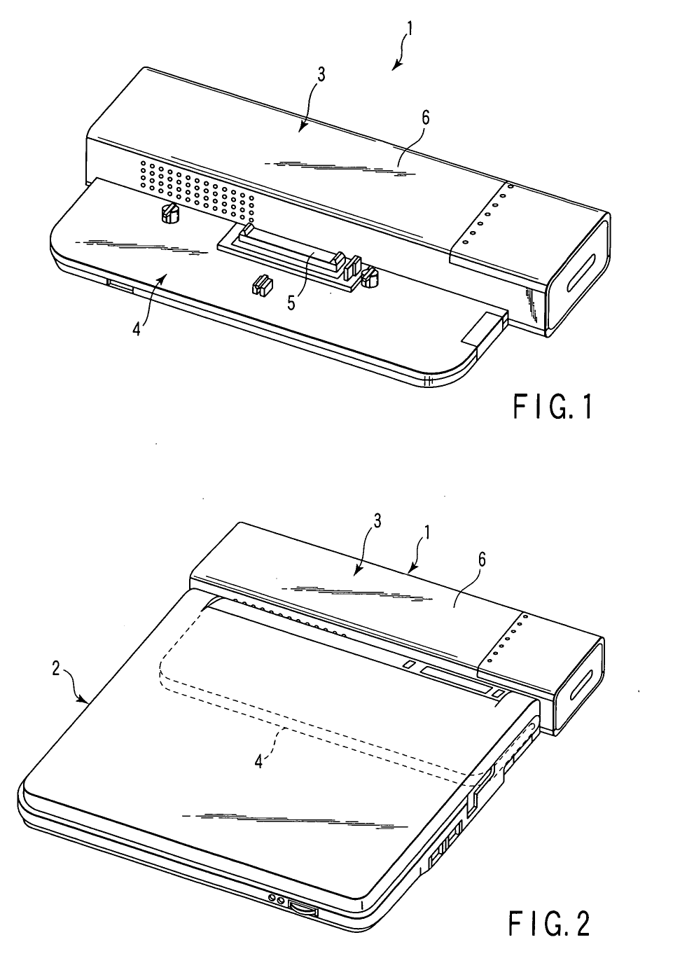

FIGS. 1 to 7 show a fuel cell unit 1 according to a first embodiment of the invention. FIG. 1 shows the entire structure of the fuel cell unit 1. The fuel cell unit 1 of the first embodiment is, for example, a DMFC fuel cell. As shown in FIG. 2, the fuel cell unit 1 has a size that enables the unit 1 to be usable as a power supply for, for example, a portable computer 2.

As can be seen from FIG. 1, the fuel cell unit 1 includes a main body 3 and mount section 4. The main body 3 has a long and narrow shape and extends in the width direction of the portable computer 2. The mount section 4 horizontally projects from the front end of the main body 3, and allows the rear end of the portable computer 2 to be mounted. A power supply connector 5 is provided on the upper surface of the mount section 4. The power supply connector 5 is electrically connected to the portable computer 2 when the computer 2 is mounted on the mount section 4.

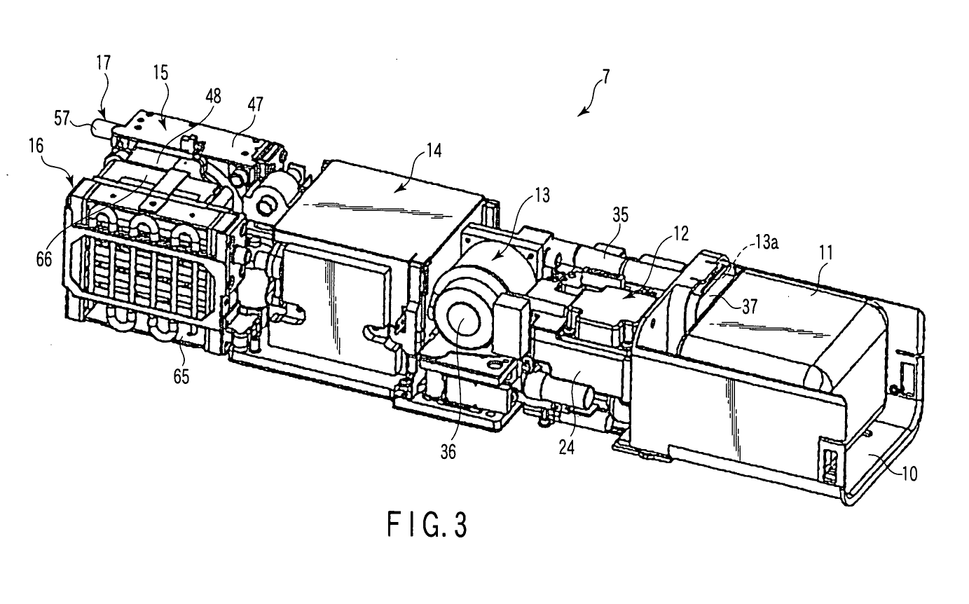

Also as can be seen from FIG. 1, the main body 3 includes a housing 6. The housing 6 contains such a DMFC unit 7 as shown in FIG. 3. The DMFC unit 7 includes a holder 10, fuel cartridge 11, mixing section 12, air inlet section 13, DMFC stack 14, cathode cooling section 15, anode cooling section 16, exhaust section 17 and control section 18.

As shown in FIG. 3, the holder 10 detachably holds the fuel cartridge 11. The fuel cartridge 11 contains methanol of high density as a liquid fuel used to generate electricity.

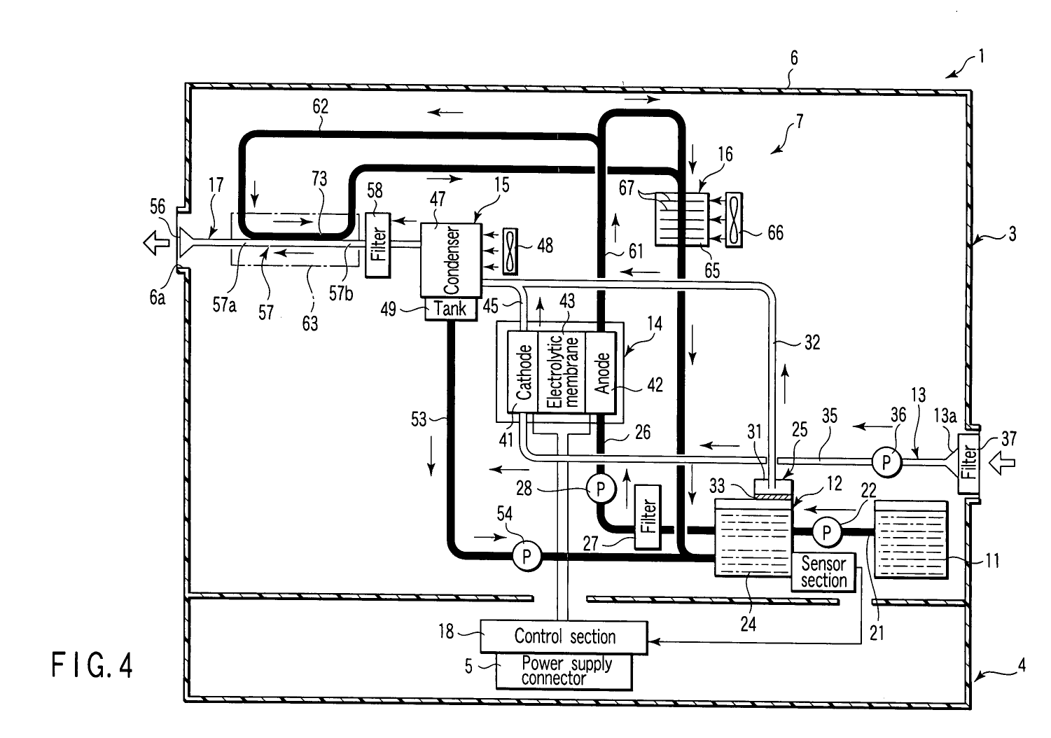

As shown in FIG. 4, the fuel cartridge 11 held by the holder 10 communicates with the mixing section 12 via a first fuel supply pipe 21. A fuel pump 22 is provided across the first fuel supply pipe 21, and used to supply methanol in the fuel cartridge 11 to the mixing section 12.

The mixing section 12 includes a mixing tank 24 and gas/solution separation section 25. The mixing tank 24 communicates with the first fuel supply pipe 21 and receives methanol from the fuel cartridge 11. The mixing tank 24 dilutes the received methanol of high density by adding water, thereby forming methanol aqueous solution with a density of several to several tens percents.

As can be seen from FIG. 4, the mixing tank 24 communicates with the DMFC stack 14 via a second fuel supply pipe 26. A filter 27 and solution feed pump 28 are provided across the second fuel supply pipe 26. The solution feed pump 28 supplies the DMFC stack 14 with the methanol aqueous solution formed by the mixing tank 24.

The gas/solution separation section 25 includes a gas/solution separation chamber 31 and first exhaust pipe 32. The gas/solution separation chamber 31 is formed as a single body with the mixing tank 24, and communicates with the interior of the tank 24. The gas/solution separation chamber 31 has a gas/solution separation membrane 33. The mixing tank 24 and gas/solution separation chamber 31 are partitioned by the gas/solution separation membrane 33. The first exhaust pipe 32 connects the gas/solution separation chamber 31 to the cathode cooling section 15 to guide the gas in the chamber 31 to the exhaust section 17 via the cathode cooling section 15.

As shown in FIG. 3, the air inlet section 13 includes an air inlet 13a, air supply pipe 35 and air feed pump 36. The air inlet 13a opens to the outside of the DMFC unit 7. An air filter 37 is attached to the air inlet 13a. The air inlet section 13 guides the outside air into the DMFC unit 7 through the air inlet 13a. As shown in FIG. 4, the air inlet 13a communicates with the DMFC stack 14 via the air supply pipe 35. The air feed pump 36 is provided across the air supply pipe 35 to supply the DMFC stack 14 with the air guided through the air inlet 13a.

The DMFC stack 14 is an example of an electricity generation section. As shown in FIG. 4, the DMFC stack 14 includes a cathode 41, anode 42 and electrolytic membrane 43. The electrolytic membrane 43 is interposed between the cathode 41 and anode 42 to partition them. The cathode 41 is supplied with an oxidizing agent, i.e., air, through the air inlet section 13. The anode 42 is supplied with the methanol aqueous solution from the mixing tank 24.

The DMFC stack 14 causes the methanol aqueous solution to react with oxygen contained in the air to thereby generate electricity. As a result, water vapor and carbon dioxide are generated as accessory products in the cathode 41 and anode 42, respectively.

Again as shown in FIG. 4, the cathode 41 of the DMFC stack 14 is connected to an end of the second exhaust pipe 45. The other end of the second exhaust pipe 45 communicates with the first exhaust pipe 32 and cathode cooling section 15. The water vapor generated by the cathode 41 and the air having passed through the cathode 41 are sent to the cathode cooling section 15 via the second exhaust pipe 45.

The cathode cooling section 15 includes a first condenser 47, first cooling fan 48 and water collection tank 49. As shown in FIG. 6, the first condenser 47 includes branching piping 50 including a plurality of branch pipes. The piping 50 branches into, for example, four branches, which extend vertically and parallel. The upper ends of the branches are again joined into one that communicates with the exhaust section 17. As a result, the fluid having passed through the cathode 41 is guided to the exhaust section 17 via the branching piping 50.

A plurality of radiator fins 51, for example, are attached to the branching piping 50. The first cooling fan 48 sends air to the radiator fins 51 to cool them. As a result, the gas in the branching piping 50, which contains water vapor, is cooled, and the amount of saturated water vapor of the gas is reduced. When the amount of saturated water vapor of the gas is reduced and the humidity reaches 100%, part of the water vapor is condensed into water. In the description, “humidity” means so-called relative humidity and indicates the ratio of the amount of vapor in the gas to the amount of saturated water vapor at each temperature.

As can be seen from FIG. 6, the water collection tank 49 is located below the first condenser 47. The water obtained by the first condenser 47 is collected by the water collection tank 49. The fluid having passed through the cathode 41 is separated into gas and water, and a required amount of water is collected. As shown in FIG. 4, the water collection tank 49 communicates with the mixing tank 24 via a collection pipe 53 and collection pump 54.

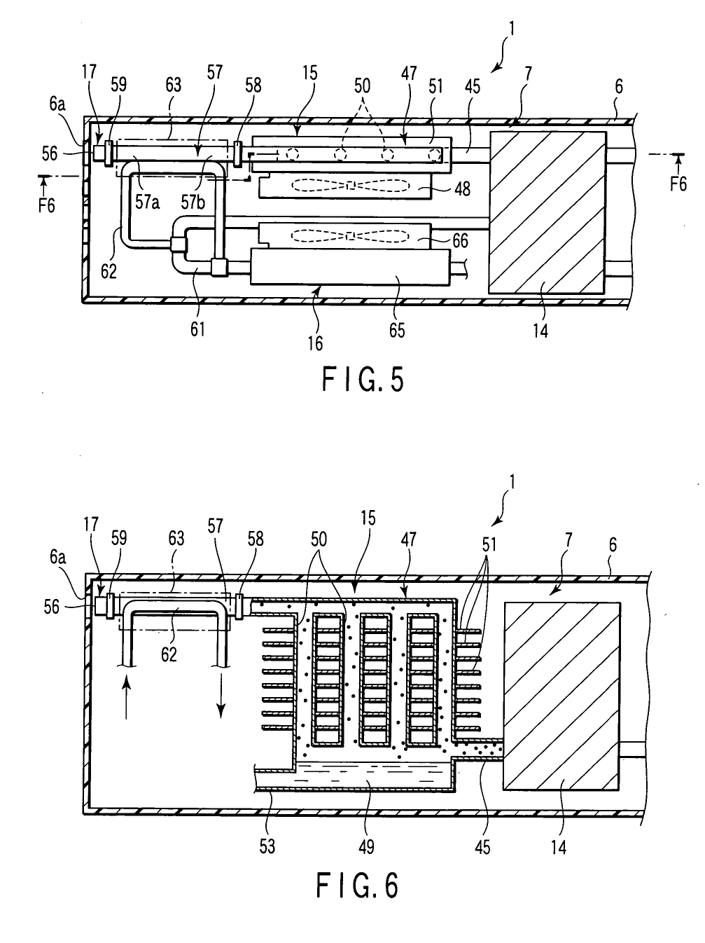

The exhaust section 17 includes an exhaust outlet 56 and exhaust pipe 57. As shown in FIG. 5, the exhaust outlet 56 opens to the outside of the housing 6 through an opening 6a formed in the housing 6. The exhaust pipe 57 communicates with the branching piping 50 of the first condenser 47, and guides, to the exhaust outlet 56, the gas passing through the cathode cooling section 15. A filter 58 and valve 59 are provided across the exhaust pipe 57.

On the other hand, the anode 42 of the DMFC stack 14 is connected to one end of a fuel return pipe 61, as shown in FIG. 4. The other end of the fuel return pipe 61 is connected to the mixing tank 24 via the anode cooling section 16. As a result, the carbon dioxide gas generated by the anode 42, and the non-reacted methanol aqueous solution are returned to the mixing tank 24 and reused for generating methanol aqueous solution.

As shown in FIG. 4, a heat exchange pipe 62 diverges from the middle portion of the fuel return pipe 61. The heat exchange pipe 62 is an example of an anode pipe. As can be seen from FIG. 5, the heat exchange pipe 62 is extended along a side of the exhaust pipe 57 in contact therewith. Namely, the heat exchange pipe 62 and exhaust pipe 57 are thermally coupled to each other via their pipe walls.

Thus, the contact portions of the heat exchange pipe 62 and exhaust pipe 57 cooperate to serve as a heat exchange section 63 for transfer of heat. The heat exchange section 63 is an example of a heat transfer mechanism for transfer, to the exhaust pipe 57, part of the heat generated by the DMFC stack 14.

More specifically, the heat exchange pipe 62 directly contacts the exhaust pipe 57 between the downstream end 57a and upstream end 57b of the exhaust pipe 57. The heat exchange pipe 62 is designed to cause the fluid contained therein to flow in the direction from the downstream end 57a of the pipe 57 to the upstream end 57b. Namely, the fluid in the heat exchange pipe 62 flows in the direction opposite to that of the gas in the exhaust pipe 57. In other words, the heat exchange section 63 is a so-called counter-flow-type heat exchange section.

Although in the first embodiment, the heat exchange pipe 62 directly contacts the exhaust pipe 57, a member of a heat transfer, such as a metal, may be interposed between the heat exchange pipe 62 and exhaust pipe 57. Further, although in the first embodiment, the heat exchange pipe 62 is thermally coupled to the exhaust pipe 57 between the filter 58 and valve 59, they may be thermally coupled, for example, upstream of the filter 58, or downstream of the valve 59.

As shown in FIG. 4, the downstream end of the heat exchange pipe 62 communicates with the fuel return pipe 61. As a result, the fluid having passed through the heat exchange pipe 62 is returned to the mixing tank 24 via the fuel return pipe 61.

The anode cooling section 16 is provided across the fuel return pipe 61. More specifically, the anode cooling section 16 is located across the pipe 61 downstream of the confluence of the pipes 61 and 62. The anode cooling section 16 includes a second condenser 65 and second cooling fan 66. The second condenser 65 includes radiator fins 67 thermally coupled to the fuel return pipe 61. The second cooling fan 66 sends air to the radiator fins 67 to cool them, whereby the fluid flowing through the fuel return pipe 61 is cooled.

The control section 18 is contained in the mount section 4. The control section 18 monitors the states the mixing section 12, air inlet section 13, DMFC stack 14, cathode cooling section 15, anode cooling section 16 and exhaust section 17, and controls the operations of the sections 12 to 17. Further, the control section 18 supplies the power supply connector 5 with the electricity generated by the DMFC stack 14.

The operation of the fuel cell unit 1 constructed as the above will now be described. Referring first to FIG. 4, the entire operation of the DMFC unit 7 will be described.

Methanol contained in the fuel cartridge 11 is sent to the mixing tank 24 via the first fuel supply pipe 21, where it is diluted with water. The resultant methanol aqueous solution is sent to the anode 42. On the other hand, the cathode 41 receives air from the air inlet section 13. Thus, the DMFC stack 14 causes the methanol aqueous solution to react with oxygen in the air, thereby generating electricity. During generation of electricity, carbon dioxide and water vapor are produced in the anode 42 and cathode 41, respectively.

The carbon dioxide gas having passed through the anode 42, and the non-reacted methanol aqueous solution are cooled by the anode cooling section 16 and returned to the mixing tank 24. The methanol aqueous solution returned to the mixing tank 24 is subjected to density adjustment, and used as a new methanol aqueous solution. This new solution is again sent to the anode 42 and reused for generating electricity.

The carbon dioxide gas returned to the mixing tank 24 is separated from the methanol aqueous solution when passing through the gas/solution separation membrane 33, and is temporarily received in the gas/solution separation chamber 31. The carbon dioxide gas in the gas/solution separation chamber 31 is sent to the cathode cooling section 15 via the first exhaust pipe 32. The carbon dioxide gas in the cathode cooling section 15 is sent to the exhaust section 17, where it is exhausted to the outside of the DMFC unit 7.

In contrast, the water vapor and air having passed through the cathode 41 are cooled by the cathode cooling section 15, whereby water is separated from the gas as a result of condensation of water vapor. The gas, from which a necessary amount of water is collected, is exhausted to the outside of the DMFC unit 7 along with the vapor remaining therein. The collected water is returned to the mixing tank 24 and reused to dilute methanol.

The operation of the heat exchange section 63 will be descried.

Part of the fluid (hereinafter referred to as the “anode circulation solution”) passing through the anode 42 is guided from the fuel return pipe 61 to the heat exchange pipe 62. During generating electricity, the DMFC stack 14 also generates heat. While flowing through the anode 42, the anode circulation solution is heated to about 50 to 60° C. The hot solution of about 50 to 60° C. flows through the heat exchange pipe 62.

In contrast, the fluid (hereinafter referred to as the “exhaust gas”) passing through the cathode 41 is cooled to about 30 to 40° C. by the cathode cooling section 15. The cool exhaust gas of about 30 to 40° C. flows through the exhaust pipe 57. At this time, the exhaust gas is in the saturated state in which its relative humidity is substantially 100%.

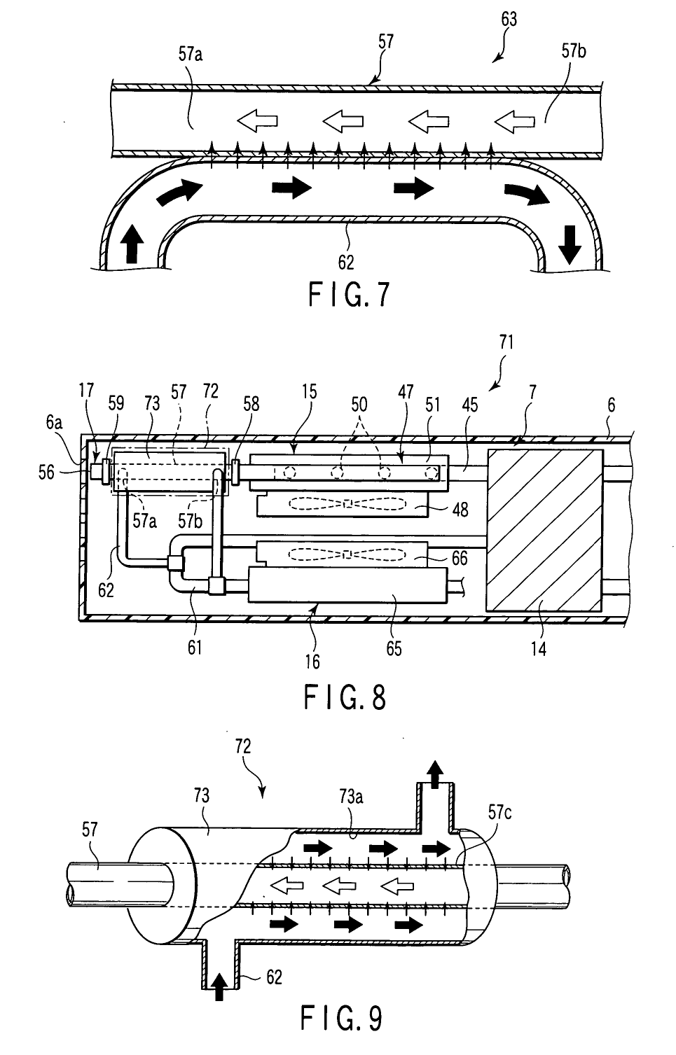

In the heat exchange section 63, the anode circulation solution and exhaust gas are thermally coupled via the walls of the heat exchange pipe 62 and exhaust pipe 57. As a result, in the heat exchange section 63, the part of heat of the anode circulation solution is transferred to the exhaust gas by, for example, heat conduction and convection, as shown in FIG. 7, whereby the temperature of the exhaust gas is increased to increase the amount of saturated water vapor of the gas.

When the amount of saturated water vapor of the exhaust gas is increased, the relative humidity of the gas is reduced even if the absolute amount of vapor contained in the exhaust gas does not change. When the relative humidity of the exhaust gas is reduced, the vapor contained therein does not easily condense. Accordingly, the exhaust gas, which is not condensed, is exhausted to the outside of the housing 6 through the exhaust outlet 56.

The anode circulation solution, from which heat is transferred to the exhaust gas, flows into the fuel return pipe 61 from the downstream end of the heat exchange pipe 62, and is cooled by the anode cooling section 16.

The fuel cell unit 1 constructed as the above is substantially prevented from condensation. Namely, as described above, part of the heat generated by the DMFC stack 14 during electricity generation is transmitted to the exhaust pipe 57, thereby reducing the relative humidity of the exhaust gas. This substantially prevents vapor contained in the exhaust gas from condensing in the exhaust pipe 57.

The heat generated by the DMFC stack 14 during electricity generation is actually waste heat that should be exhausted to the outside of the fuel cell unit 1. By effectively utilizing the waste heat to heat the exhaust gas, no particular heating devices are necessary.

The fuel cell unit 1 may be used as a power supply for electronic devices, such as the portable computer 2. Accordingly, the prevention of condensation in the fuel cell unit 1 also contributes to the prevention of malfunction or failure of the electronic devices.

It is efficient to use the pipe for circulating the anode circulation solution as the mechanism for heating the exhaust gas utilizing the waste heat generated by the DMFC stack 14. The fuel cell unit 1 of the first embodiment can be realized simply by attaching, for example, the fuel exchange pipe. This contributes to the cost reduction of the fuel cell unit 1.

Further, the supply of the heat of the anode circulation solution to the exhaust gas means the absorption of part of the heat of the anode circulation solution by the exhaust gas. Since the anode circulation solution is later cooled by the anode cooling section 16, the absorption of the heat of the anode circulation solution by the heat exchange section 63 assists the cooling operation of the anode cooling section 16.

Since the heat exchange pipe 62 is located in contact with the exhaust pipe 57, the heat exchange section 63 can be made simplest in structure, and the fuel cell unit 1 can be made compact.

The structure of the heat exchange section 63 is not limited to the above-described counter-flow type. For instance, a heat exchange section of a parallel-flow type, in which the anode circulation solution and exhaust gas flow in the same direction, may be employed. Alternatively, a heat exchange section of a perpendicular-flow type, in which the anode circulation solution and exhaust gas flow at right angles to each other, may be employed.

In the first embodiment, part of the fuel return pipe 61 branches as the heat exchange pipe 62 incorporated in the heat exchange section 63. However, the fuel return pipe 61 may be directly guided to the heat exchange section 63, without separating the heat exchange pipe 62 from the fuel return pipe 61, thereby transferring heat to the exhaust pipe 57.

It is one example to transmit heat to the exhaust gas to much increase the temperature of the exhaust gas at the heat exchange section 63. However, it is sufficient even if the temperature of the exhaust gas does not increase. If the temperature of the exhaust gas does not reduce so much until it reaches the exhaust outlet 56, condensation in the exhaust pipe 57 can be avoided.

Referring then to FIGS. 8 and 9, a fuel cell unit 71 according to a second embodiment of the invention will be described. In the second embodiment, elements similar to those of the fuel cell unit 1 of the first embodiment are denoted by corresponding reference numbers, and no description is given thereof.

As can be seen from FIG. 8, the fuel cell unit 71 includes a heat exchange section 72. The heat exchange section 72 has a double piping structure as shown in FIG. 9. Specifically, the heat exchange pipe 62 of the heat exchange section 72 has a large-diameter portion 73 larger than the other portions. The large-diameter portion 73 extends along the exhaust pipe 57, with the exhaust pipe 57 contained therein. The large-diameter portion 73 permits the anode circulation solution to flow between the outer peripheral surface 57c of the exhaust pipe 57 and the inner peripheral surface 73a of the large-diameter portion 73.

More specifically, the large-diameter portion 73 permits the anode circulation solution to flow from the downstream end 57a of the exhaust pipe 57 to the upstream end 57b of the same. Namely, the anode circulation solution in the large-diameter portion 73 flows in a direction opposite to that of the exhaust gas in the exhaust pipe 57. In other words, the heat exchange section 72 is a so-called counter-flow type heat exchange section. However, the heat exchange section 72 is not limited to this structure, but may be of the parallel-flow type or perpendicular-flow type.

The fuel cell unit 71 constructed as the above is substantially prevented from condensation therein. That is, in the fuel cell unit 71, heat is transferred to the exhaust gas to reduce the relative humidity of the exhaust gas, as in the first embodiment. As a result, the vapor contained in the exhaust gas can be prevented from condensing in the exhaust pipe 57.

Further, in the fuel cell unit 71, the heat exchange section 72 has a double piping structure, therefore the heat exchange pipe 62 is effectively thermally coupled with the exhaust pipe 57. Namely, since the exhaust pipe 57 can receive heat from the entire peripheral surface as shown in FIG. 9, the heat exchange efficiency of the heat exchange section 72 may be higher than that of the heat exchange section 63 of the first embodiment, which further reliably prevents condensation in the fuel cell unit 71.

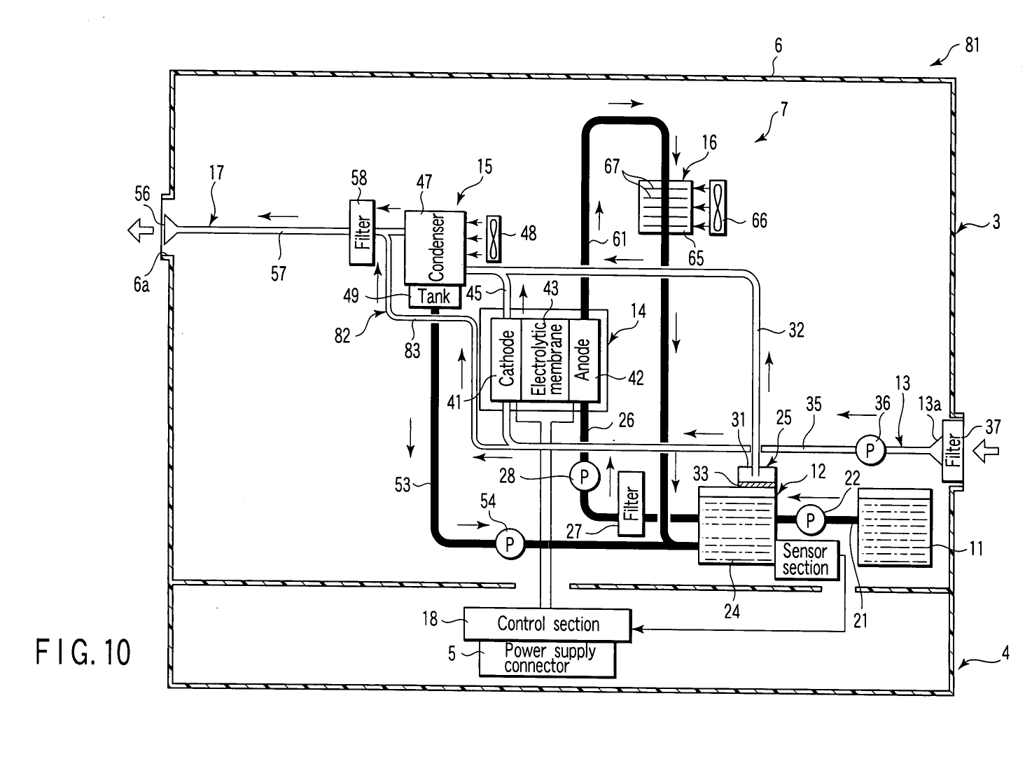

Referring then to FIGS. 10 and 11, a fuel cell unit 81 according to a third embodiment of the invention will be described. In the third embodiment, elements similar to those of the fuel cell unit 1 of the first embodiment are denoted by corresponding reference numbers, and no description is given thereof.

As can be seen from FIGS. 10 and 11, the fuel cell unit 81 includes a gas supply mechanism 82. The gas supply mechanism 82 includes a gas supply pipe 83. The upstream end of the gas supply pipe 83 diverges from the middle portion of the air supply pipe 35. The downstream end of the gas supply pipe 83 communicates with the exhaust pipe 57. Further, as shown in FIG. 11, the gas supply pipe 83 extends near the DMFC stack 14. Part of the gas supply pipe 83 is adjacent to the DMFC stack 14.

In the third embodiment, the gas supply pipe 83 is coupled to the exhaust pipe 57 upstream of the filter 58. However, the gas supply pipe 83 may be coupled to the exhaust pipe 57 downstream of the filter 58.

The operation of the fuel cell unit 81 will be described.

The air guided into the DMFC unit 7 through the air inlet 13a is fed by the air feed pump 36 to the DMFC stack 14 via the air supply pipe 36. Part of the air fed to the DMFC stack 14 is guided to the gas supply pipe 83 diverging from the air supply pipe 35.

The gas supply pipe 83 extends near the DMFC stack 14. Accordingly, the air flowing through the gas supply pipe 83 receives heat from the DMFC stack 14 when it passes near the DMFC stack 14.

The air in the gas supply pipe 83 is directly guided into the exhaust pipe 57 without passing through the cathode 41. The relative humidity of the air in the gas supply pipe 83 is substantially the same as that of the atmosphere, since the air does not pass through the cathode cooling section 15. Namely, the air guided from the gas supply pipe 83 has a lower humidity than the exhaust gas in the exhaust pipe 57.

When air of a lower humidity is guided from the gas supply pipe 83 to the exhaust pipe 57, the relative humidity of gas in the exhaust pipe 57 is reduced. If, for example, air with a humidity of 50% is mixed into an exhaust gas with a humidity of 100%, the humidity of the exhaust gas in the exhaust pipe 57 is reduced to, for example, 70%. When the humidity of the exhaust gas is reduced, the exhaust gas does not easily condense, and may be exhausted without condensation to the outside of the housing 6 through the exhaust outlet 56.

Furthermore, the air in the gas supply pipe 83 is heated by the DMFC stack 14 when it passes near the DMFC stack 14. Accordingly, when the air in the gas supply pipe 83 is guided into the exhaust pipe 57, the temperature of the exhaust gas in the exhaust pipe 57 is increased. At this time, the amount of saturated water vapor of the exhaust gas is increased, and hence the relative humidity in the exhaust pipe 57 is further reduced.

The fuel cell unit 81 constructed as the above is substantially prevented from condensation. Namely, air of a lower humidity is mixed into the exhaust gas in the exhaust pipe 57 to dilute the same, thereby reducing the humidity in the exhaust pipe 57. This substantially prevents condensation in the exhaust pipe 57 even when the temperature of the exhaust gas is somewhat reduced in the exhaust pipe 57.

The heat exchange sections 63 and 72 employed in the first and second embodiments, respectively, differ from the gas supply mechanism 82 in that whether the amount of saturated vapor of the exhaust gas is increased, or the exhaust gas in the exhaust pipe 57 is diluted with dry air. However, the heat exchange sections 63 and 72 and gas supply mechanism 82 are similar in the function of reducing the relative humidity of the exhaust gas, and realize the substantial prevention of condensation in the exhaust pipe 57, utilizing this function.

As one example of the gas supply mechanism, it includes the gas supply pipe 83. The fuel cell unit 81 of the third embodiment can be realized simply by attaching, for example, the gas supply pipe 83. This contributes to the cost reduction of the fuel cell unit 81.

Furthermore, since the gas supply pipe 83 extends near the DMFC stack 14, the exhaust gas is heated by the air guided from the gas supply pipe 83, thereby more reliably preventing condensation in the fuel cell unit 81. However, it is not always necessary to locate the gas supply pipe 83 near the DMFC stack 14. Even if air of the room temperature is mixed into the exhaust gas in the exhaust pipe 57, the fuel cell unit 81 may be prevented from condensation.

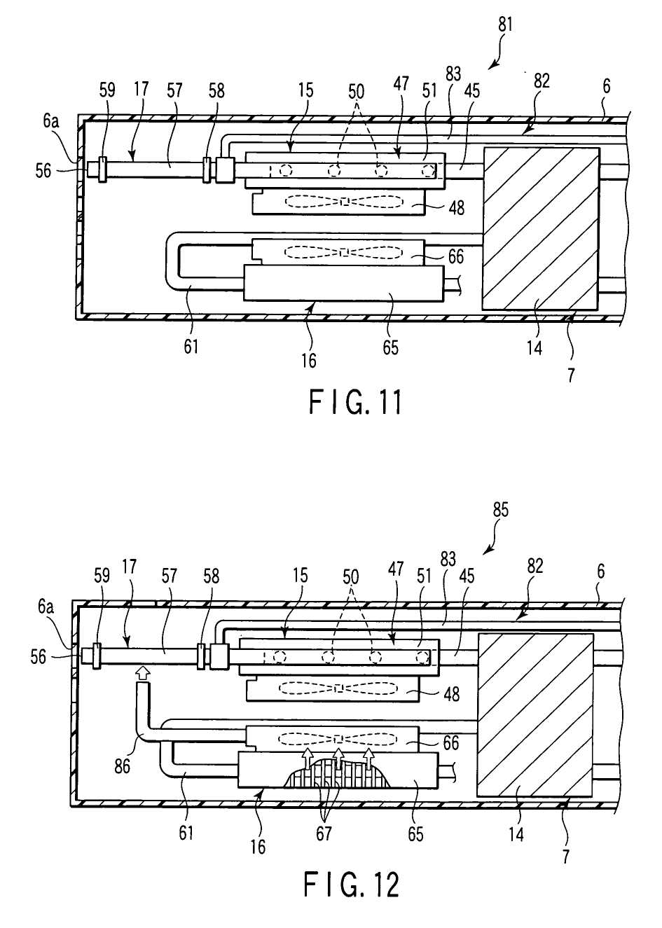

FIG. 12 shows a fuel cell unit 85 according to a modification of the third embodiment. As shown, the anode cooling section 16 of the fuel cell unit 85 includes the second cooling fan 66. One end of a pipe 86 is coupled to the exhaust hole of the second cooling fan 66. The other end of the pipe 86 extends and opens toward the lateral portion of the exhaust pipe 57 of the DMFC unit 7. The pipe 86 discharges, to the exhaust pipe 57, the air exhausted by the second cooling fan 66.

The fuel cell unit 85 constructed as the above can more reliably prevent condensation in the unit. Namely, the radiator fins 67 of the anode cooling section 16 are heated by the anode circulation solution passing through the second condenser 65. Accordingly, the air around the radiator fins 67 is also heated by the fins 67.

The second cooling fan 66 draws the heated air from around the radiator fins 67, and sends it to the periphery of the exhaust pipe 57 via the pipe 86. Namely, the second cooling fan 66 heats the exhaust pipe 57 using the air that has cooled the radiator fins 67.

Thus, the exhaust pipe 57 is heated to thereby increase the temperature of the exhaust gas in the pipe 57. When the temperature of the exhaust gas is increased, the relative humidity of the exhaust gas is reduced as described above, with the result that condensation is less likely to occur. Note that the pipe 86 can be provided for the second cooling fan 66 regardless of whether the fuel cell unit employs the gas supply mechanism 82.

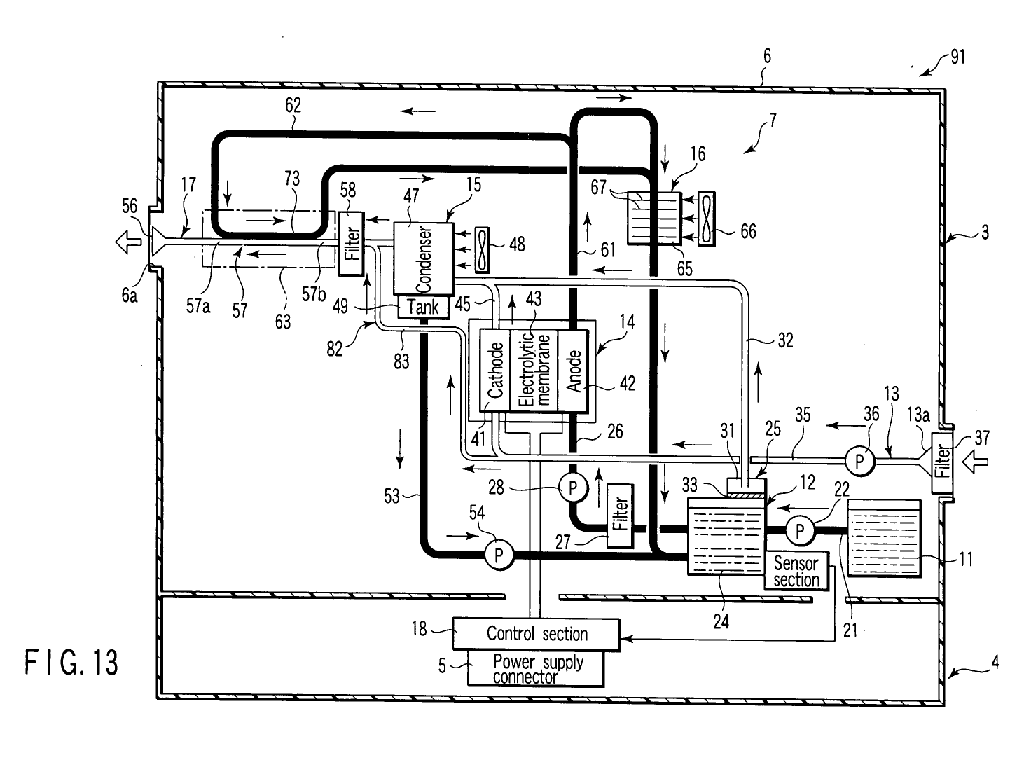

Referring to FIG. 13, a fuel cell unit 91 according to a fourth embodiment of the invention will be described. In the fourth embodiment, elements similar to those of the fuel cell units 1 and 81 of the first and third embodiments are denoted by corresponding reference numbers, and no description is given thereof.

As can be seen from FIG. 13, the fuel cell unit 91 includes the heat exchange section 63 and gas supply mechanism 82. That is, the fuel cell unit 91 is the combination of the fuel cell units 1 and 81 of the first and third embodiments.

The fuel cell unit 91 constructed as the above is substantially prevented from condensation therein. Namely, in the fuel cell unit 91, part of the heat generated by the DMFC stack 14 during generation of electricity is transferred to the exhaust pipe 57 to reduce the relative humidity of the exhaust gas, as in the fuel cell unit 1 of the first embodiment.

Further, a gas of a lower relative humidity is mixed into the exhaust gas, using the gas supply mechanism 82, thereby further reducing the relative humidity of the exhaust gas. Consequently, the moisture in the exhaust gas can be effectively prevented from condensing in the exhaust pipe 57, compared to the first and third embodiments.

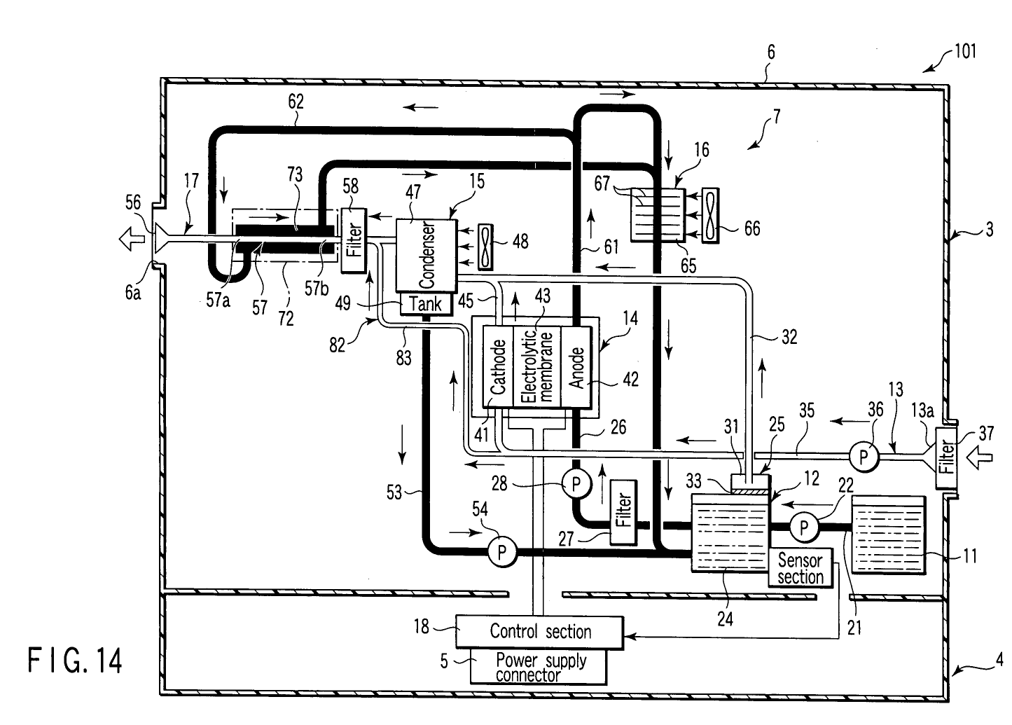

A fuel cell unit 101 according to a fifth embodiment of the invention will be described with reference to FIG. 14. In the fifth embodiment, elements similar to those of the fuel cell units 1, 71 and 81 of the first, second and third embodiments are denoted by corresponding reference numbers, and no description is given thereof.

As can be seen from FIG. 14, the fuel cell unit 101 includes the heat exchange section 72 and gas supply mechanism 82. That is, the fuel cell unit 101 is the combination of the fuel cell units 71 and 81 of the second and third embodiments.

The fuel cell unit 101 constructed as the above is substantially prevented from condensation therein. Namely, in the fuel cell unit 101, part of the heat generated by the DMFC stack 14 during generation of electricity is transferred to the exhaust pipe 57 to reduce the relative humidity of the exhaust gas, as in the fuel cell unit 71 of the second embodiment.

Further, a gas of a lower relative humidity is mixed into the exhaust gas, using the gas supply mechanism 82, thereby further reducing the relative humidity of the exhaust gas. Consequently, the moisture in the exhaust gas can be effectively prevented from condensing in the exhaust pipe 57, compared to the second and third embodiments.

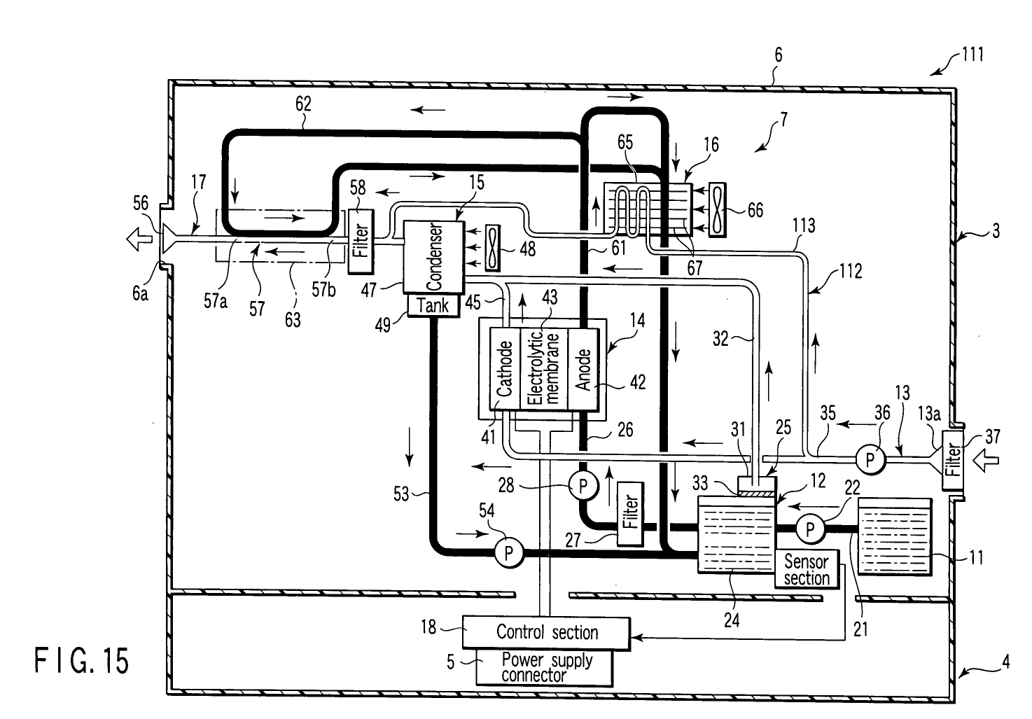

A fuel cell unit 111 according to a sixth embodiment of the invention will be described with reference to FIG. 15. In the sixth embodiment, elements similar to those of the fuel cell units 1, 71 and 81 of the first, second and third embodiments are denoted by corresponding reference numbers, and no description is given thereof.

As can be seen from FIG. 15, the fuel cell unit 111 includes the heat exchange section 63 and a gas supply mechanism 112. The gas supply mechanism 112 includes a gas supply pipe 113. The upstream end of the gas supply pipe 113 diverges from the middle portion of the air supply pipe 35. The downstream end of the gas supply pipe 113 communicates with the exhaust pipe 57.

Further, the gas supply pipe 113 is thermally coupled to the radiator fins 67 of the anode cooling section 16. Namely, part of the heat of the cathode circulation solution is transferred to the gas supply pipe 113 via the radiator fins 67 to heat the air passing through the gas supply pipe 113.

In the sixth embodiment, the gas supply pipe 113 communicates with the exhaust pipe 57 upstream of the filter 58. However, the gas supply pipe 113 may communicate with the exhaust pipe 57 downstream of the filter 58.

The fuel cell unit 111 constructed as the above is substantially prevented from condensation therein. Namely, in the fuel cell unit 111, a gas of a lower relative humidity is mixed into the exhaust gas, using the gas supply mechanism 112, thereby reducing the relative humidity of the exhaust gas, as in the fuel cell unit 81 of the third embodiment. Consequently, the moisture in the exhaust gas can be prevented from condensing in the exhaust pipe 57.

Further, since the gas supply pipe 113 is thermally coupled to the radiator fins 67, the exhaust gas is heated by the air mixed therein through the gas supply pipe 113. As a result, condensation in the fuel cell unit 111 can be further effectively prevented.

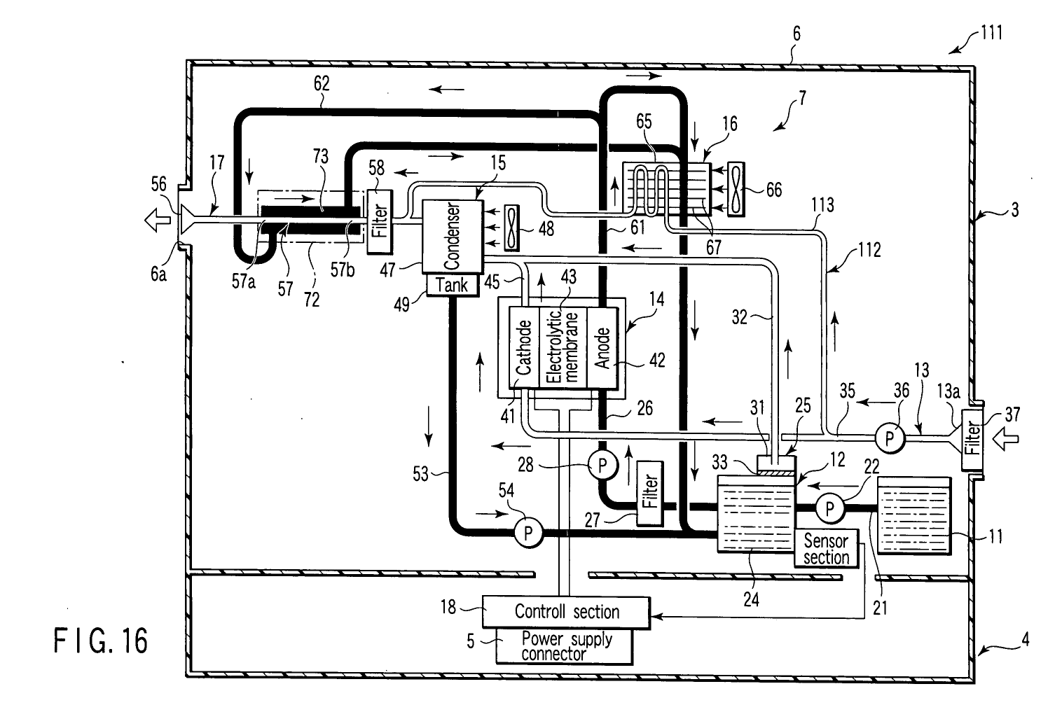

Although the sixth embodiment employs the heat exchange section 63, it may employ the heat exchange section 72 shown in FIG. 16, instead of the heat exchange section 63. In addition, the gas supply mechanism 112 may be employed solely without the heat exchange section 63 or 72.

The present invention is not limited to the above-described fuel cell units 1, 71, 81, 91, 101 and 111 of the first to sixth embodiments. For instance, the components employed in the first to sixth embodiments may be selectively combined in accordance with the size and/or purpose of the fuel cell unit.

Specifically, a gas supply pipe with a dedicated gas inlet and gas feed pump may be employed, instead of the gas supply pipe 83 or 113 diverging from the air supply pipe 35.

The fuel cell unit, to which an embodiment of the invention is applied, is not limited to a DMFC, but may be a fuel cell unit using another alcohol, such as ethanol, or other liquid fuels. The invention is not limited to fuel cell units for portable computers, but is also applicable to those for electronic devices, such as cellular phones or digital cameras, or for vehicles.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A fuel cell unit comprising:
a housing;
an electromotive section contained in the housing and including an anode and a cathode;
a cooling section which cools a fluid having passed through the cathode and separates the fluid into a gas and a liquid;
an exhaust pipe which guides, to an outside of the housing, the gas separated by the cooling section; and
a heat transfer mechanism which transfers, to the exhaust pipe, part of heat generated by the electromotive section.

2. The fuel cell unit according to claim 1, wherein the heat transfer mechanism includes an anode pipe which guides the fluid having passed through the anode, and part of the anode pipe is thermally coupled to the exhaust pipe.

3. The fuel cell unit according to claim 2, wherein the part of the anode pipe extends along the exhaust pipe in contact with the exhaust pipe.

4. The fuel cell unit according to claim 3, wherein the fluid having passed through the anode passes through the part of the anode pipe in a direction opposite to a direction in which the gas passes through the exhaust pipe.

5. The fuel cell unit according to claim 2, wherein the part of the anode pipe contains part of the exhaust pipe, and the fluid having passed through the anode passes between an outer surface of the exhaust pipe and an inner surface of the anode pipe.

6. The fuel cell unit according to claim 5, wherein the fluid having passed through the anode passes through the part of the anode piping in a direction opposite to a direction in which the gas passes through the exhaust pipe.

7. The fuel cell unit according to claim 2, further comprising a gas supply mechanism which supplies, into the exhaust pipe, a gas having a lower humidity than a humidity of the gas passing through the exhaust pipe.

8. The fuel cell unit according to claim 7, further comprising an air inlet section which supplies air to the cathode, and wherein the gas supply mechanism includes a gas supply pipe which causes part of air passing through the air inlet section to bypass the cathode and directly reach the exhaust pipe.

9. The fuel cell unit according to claim 8, wherein the gas supply pipe extends near the electromotive section.

10. The fuel cell unit according to claim 8, further comprising an anode cooling section which includes fins and cools the fluid having passed through the anode, the gas supply pipe being thermally coupled to the fins.

11. A fuel cell unit comprising:
a housing;
an electromotive section contained in the housing and including an anode and a cathode;
a cooling section which cools a fluid having passed through the cathode and separates the fluid into a gas and a liquid;
an exhaust pipe which guides, to an outside of the housing, the gas separated by the cooling section; and
a gas supply mechanism which supplies, to the exhaust pipe, a gas having a lower humidity than the gas passing through the exhaust pipe.

12. The fuel cell unit according to claim 11, further comprising an air inlet section which supplies air to the cathode, and wherein the gas supply mechanism includes a gas supply pipe which causes part of air passing through the air inlet section to bypass the cathode and directly reach the exhaust pipe.

13. The fuel cell unit according to claim 12, wherein the gas supply pipe extends near the electromotive section.

14. The fuel cell unit according to claim 12, further comprising an anode cooling section which includes fins and cools the fluid having passed through the anode, the gas supply pipe being thermally coupled to the fins.
